(19) United States
(12) Patent Application Publication
(10) Pub. No.: US 2013/0179396 A1
(43) Pub. Date: Jul. 11, 2013

(54) Defining and Detecting Bundle Information in Databases

(71) Applicant: International Business Machines Corporation, Armonk, NY (US)

(72) Inventors: Pawel Gocek, Lodz (PL); Bartlomiej Tomasz Malecki, Slomniki (PL)

(73) Assignee: INTERNATIONAL BUSINESS MACHINES CORPORATION, Armonk, NY (US)

(21) Appl. No.: 13/741,502

(22) Filed: Jan. 15, 2013

Related U.S. Application Data
(63) Continuation of application No. 13/345,869, filed on Jan. 9, 2012.

(51) Int. Cl. G06F 17/30

(52) U.S. Cl. CPC G06F 17/30312
USPC 707/609; 707/640

(57) ABSTRACT

An approach is provided to registering a database at a database manager in a manner that defines software bundles. Registering the database involves receiving database metadata that corresponds to the database which is stored in a metadata data store that is maintained by the database manager. A software product associated with the registered database is processed by receiving software product metadata corresponding to the software product and this software product metadata is also stored in the metadata data store maintained by the database manager.

### TECHNICAL FIELD

The present disclosure relates to an approach that detects software bundles using information stored in database instances. In particular, the present disclosure addresses software discovery by matching software applications with the database instance used by the respective applications.

### BACKGROUND OF THE INVENTION

A challenge in software discovery is matching software applications with the database instance used by the application, also known as discovering the software bundle. Existing, traditional, heuristic methods give low level of confidence and are resource consuming. Examples of such traditional methods include monitoring TCP/IP connections (port monitoring). However, port monitoring often fails in situations where multiple databases are created under a single instance or in environments where the communication protocol used is something other then TCP/IP. An additional challenge with this approach is that the TCP/IP connection is not established for the whole lifetime of the application. Because of this, monitoring agents are used to intercept the exact moment of connection and these monitoring agents can degrade system performance. Another traditional approach used for software discovery is software tagging. In software tagging, information about bundling relationships is stored in text/xml files stored with the application. This approach also has drawbacks: First, the database image is unaware of bundling information. In addition, the tags fail to keep track of situations in which multiple applications use a common database instance. Second, software tagging is often not applicable for remote installation as direct access to the computer system is often needed in order to place the tag file.

### SUMMARY

An approach is provided to registering a database at a database manager in a manner that defines software bundles. Registering the database involves receiving database metadata that corresponds to the database which is stored in a metadata data store that is maintained by the database manager. A software product associated with the registered database is processed by receiving software product metadata corresponding to the software product and this software product metadata is also stored in the metadata data store maintained by the database manager.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a high-level diagram showing product data being included in database metadata during database registration and later used during software discovery;

FIG. 4 is a flowchart showing steps taken by the database manager during registration of a database which can include software product data;

FIG. 5 is a diagram showing a sample database entry with associated software product data; and

FIG. 6 is a flowchart showing steps performed by the discovery process as well as steps performed by automated bundling tools that utilize the registered application data.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention. Instead, the following is intended to provide a detailed description of an example of the invention and should not be taken to be limiting of the invention itself. Rather, any number of variations may fall within the scope of the invention, which is defined by the claims that follow the description.

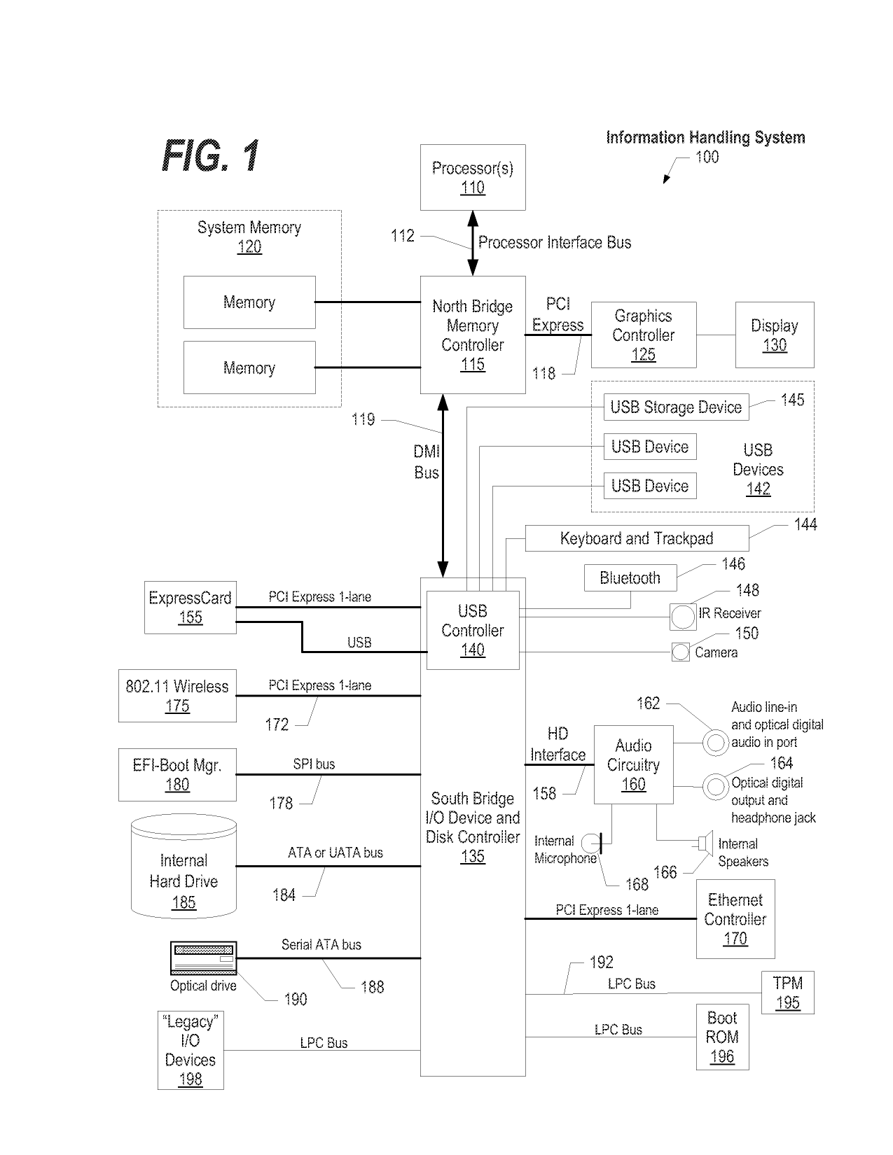

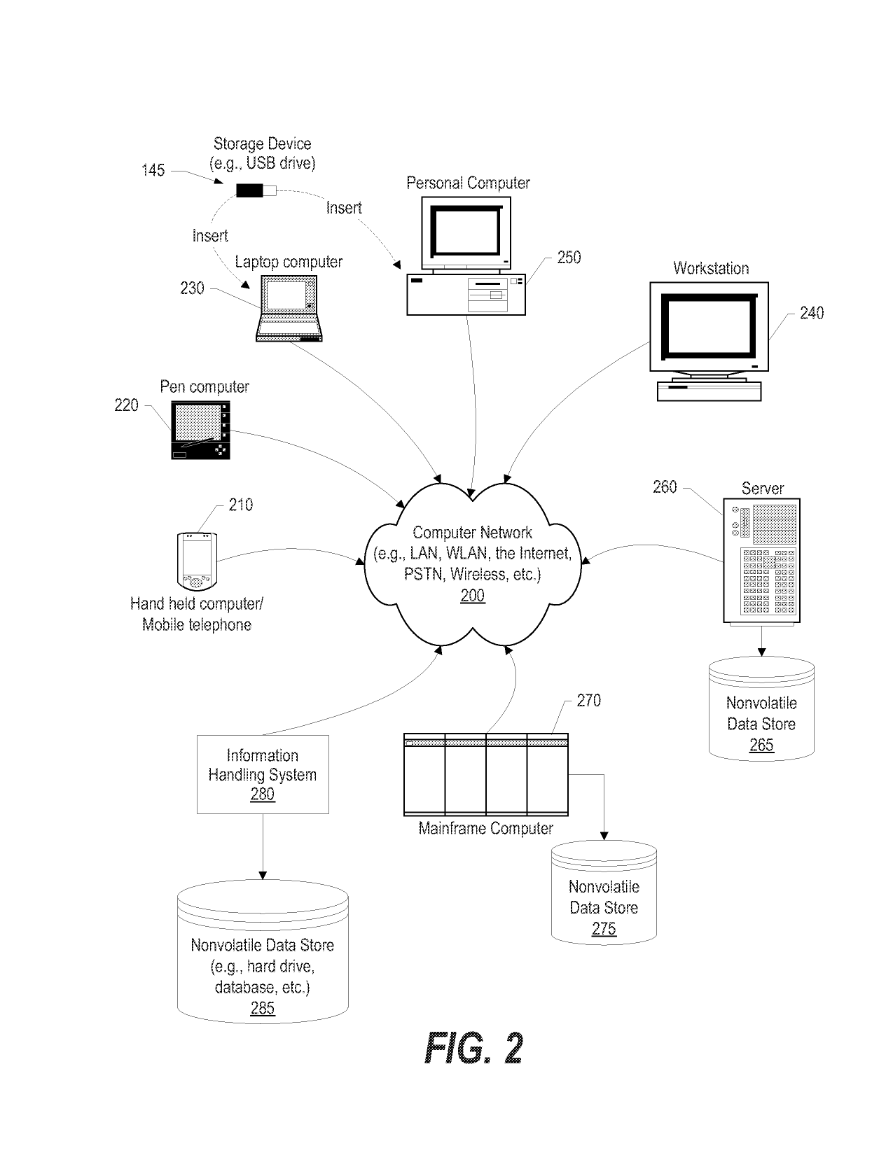

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE .802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

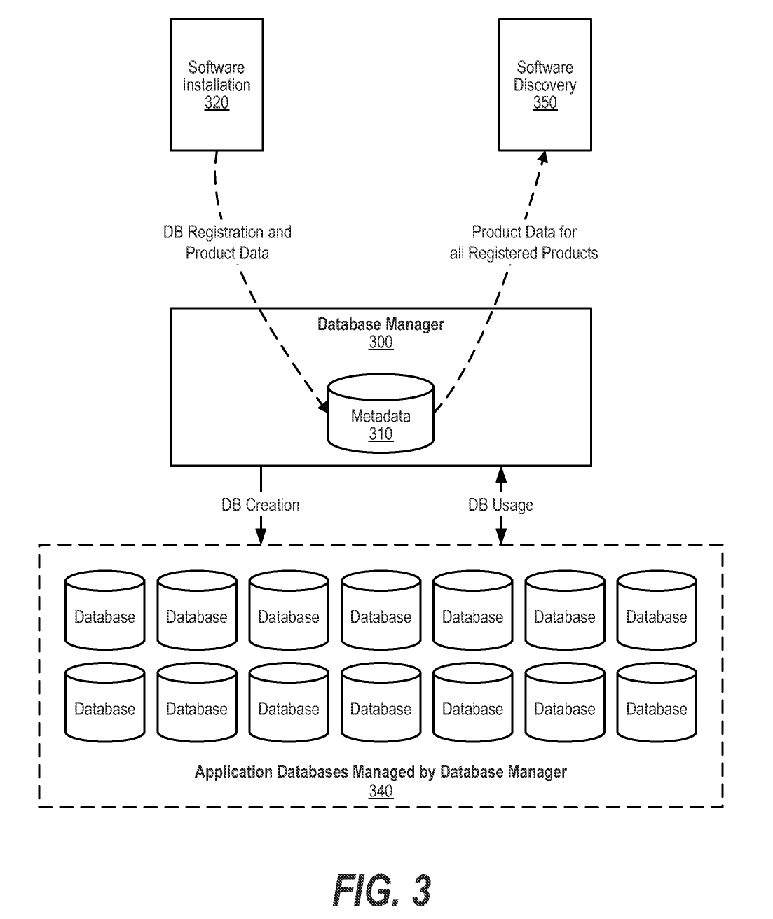

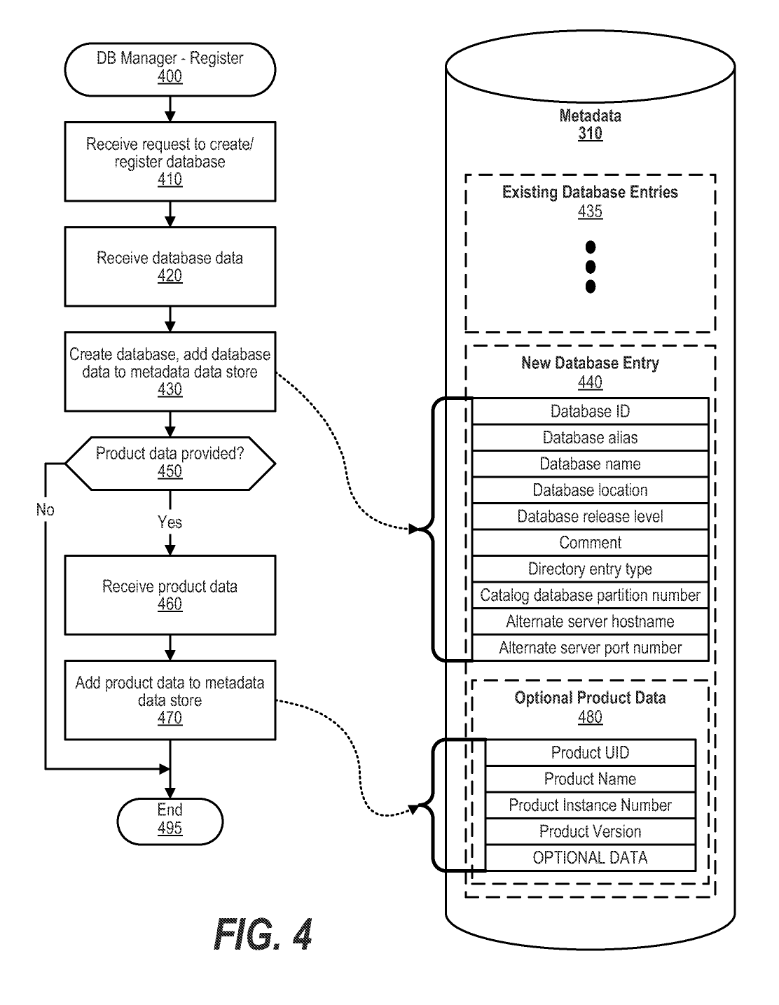

FIG. 3 is a high-level diagram showing product data being included in database metadata during database registration and later used during software discovery. Database manager 300, such as DB2™ Database Manager licensed to licensees by the International Business Machines Corporation, manages a number of databases 340, such as application databases utilized by various software products. During software installation process 320, the database utilized by a software product is registered with database manager 300. During database registration, database metadata, such as the database metadata fields shown in entry 440 on FIG. 4, are received. The received metadata is stored in the database manager's metadata data store 310. The metadata data store is a data store that is stored on the database manager level thereby preserving the metadata data store during database backup procedures and restored during database restoration procedures using traditional database backup and restore commands. The software product that is being installed is associated with the database that is being registered. Again, metadata pertaining to the software product is received (see software product metadata fields shown in entry 470 on FIG. 4) and this metadata is stored in metadata data store 310.

During software discovery process 350, the metadata stored in metadata data store 310 is scanned, such as by utilizing a traditional database directory command, that retrieves the registered application metadata from the metadata data store and this retrieved metadata is used by automated software bundling tools to identify bundling relationships between the software products and the registered databases.

FIG. 4 is a flowchart showing steps taken by the database manager during registration of a database which can include software product data. Processing commences at 400 whereupon, at step 410, the system receives a request to create and register a database at a database management system (e.g., during a software product installation, etc.). At step 420, database metadata corresponding to the database that is being created/registered is received (e.g., during the software product installation, by the system administrator, etc.). At step 430, the database is created by the database manager and the received database metadata is added to the metadata data store that is maintained by the database manager.

Metadata data store 310 includes information about the various databases created and registered at the database manager. Existing database entries 435 are those databases that were created and registered before the database that is currently being created and registered at the database manager. Existing database entries 435 may also include optional software product metadata that is associated with the various existing databases, as described below. New database entry 440 is added to metadata data store 310 to store the database metadata corresponding to the database that is currently being created and registered at the database manager. In one embodiment, the various database metadata includes a variety of data elements such as a database identifier, a database alias, a database name, a database location, a database release level, a comment regarding the database, a database entry type, a catalog database partition number, an alternate server hostname, and an alternate server port number. Some of these data elements may be excluded depending on the particular database manager being used and, likewise, additional data elements may be added (included) based on the database manager that is being used.

A decision is made as to whether software product data is being provided along with the database metadata (decision 450). When a software product is being installed, the software product can be associated with the newly registered database. In this case, decision 450 branches to the “yes” branch whereupon, at step 460, the system receives software product metadata (e.g., from the system administrator creating and registering the database and installing the software product, etc.). At step 470, the system adds the received software product metadata to metadata data store 310 and associates the data with the newly registered database. Software product metadata 480 includes a number of data elements related to the software product. These data elements may include the software product identifier, the software product name, the software product instance number, the software product version, and any other software product optional data. In one embodiment, multiple software products can be associated with a given database. Returning to decision 450, if the particular database that is being created and registered is not associated with a software product, then decision 450 branches to the “no” branch bypassing steps 460 and 470. Registration processing performed at the database manager thereafter ends at 495.

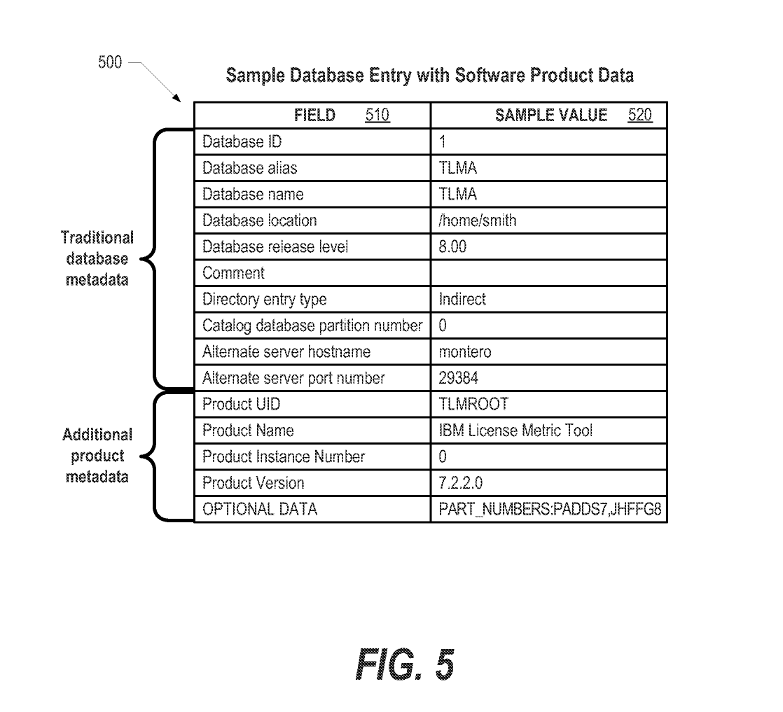

FIG. 5 is a diagram showing a sample database entry with associated software product data. Sample entry 500 is a sample record (entry) in the metadata data store. Shown are a number of fields 510 with corresponding sample values 520. The fields include both traditional database metadata 530 as well as software product metadata 540. The traditional database metadata fields and their corresponding values are as shown in the figure. Note that, in the sample implementation, if the database (here named “TLMA”) was not associated with a software product then the values corresponding to the software metadata fields would be blank. However, in the sample shown, the registered database is associated with a software product with an identifier of “TLMROOT” and a name of “IBM License Metric Tool.”

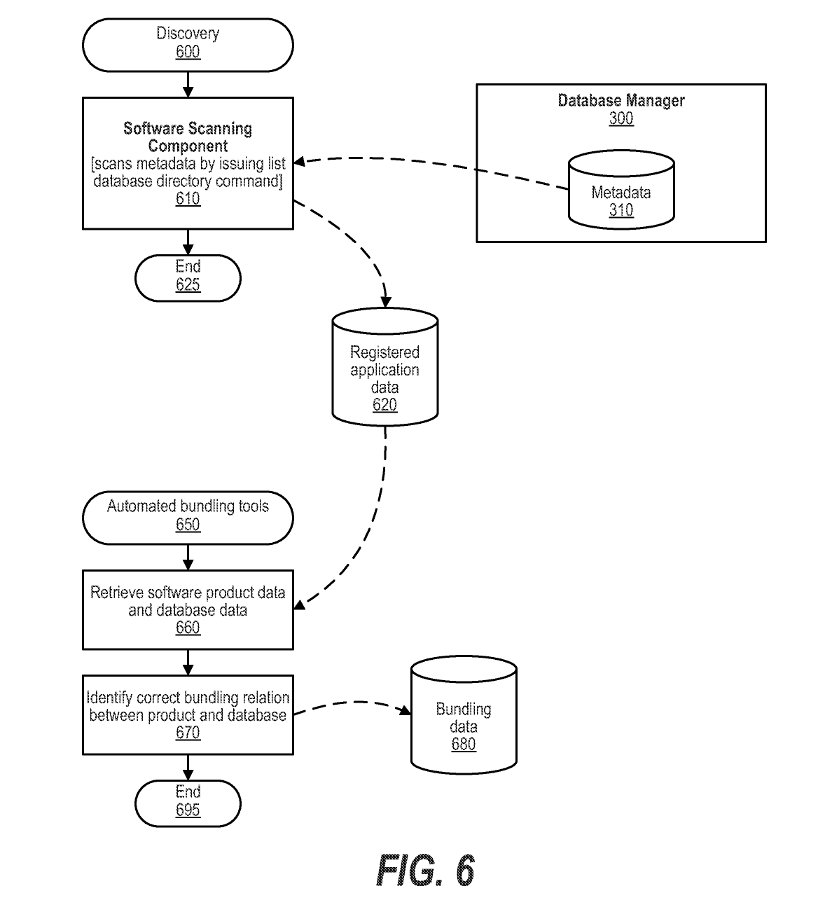

FIG. 6 is a flowchart showing steps performed by the discovery process as well as steps performed by automated bundling tools that utilize the registered application data. Discovery processing commences at 600 whereupon, at step 610, the discovery process performs a software scanning routine that scans metadata data store 310 maintained by database manager 310. In one embodiment, a standard list database directory command is issued which results metadata corresponding to the various databases managed by the database manager being written to a data store (registered application data store 620). Because the software product metadata associated with the registered databases is included in metadata data store 310, the software product metadata is included in the resulting data that is written to data store 620. Discovery process thereafter ends at 625.

Automated bundling tools processing is shown commencing at 650. These tools are used to identify bundling relationships between software products and databases. At step 660, the automated bundling tool retrieves the software product metadata and the database metadata that was written to data store 620 by the discovery process. At step 670, the retrieved software products metadata and associated database metadata are used to identify correct bundling relationships between the software products and the databases being managed by the database manager. The identified bundling relationships are written to bundling data store 680. Processing by the automated bundling tools thereafter ends at 695.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive). Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method implemented by an information handling system comprising:
registering a database at a database manager, wherein the registering includes:
receiving a plurality of database metadata corresponding to the database; and
storing, in a metadata data store maintained by the database manager, the received database metadata;
associating a software product with the registered database, wherein the associating includes:
receiving a plurality of software product metadata corresponding to the software product; and
storing, in the metadata data store maintained by the database manager, the received software product metadata, wherein the stored software product metadata is associated with the stored database metadata.

2. The method of claim 1 further comprising:
scanning the metadata data store as part of a software discovery process; and
retrieving, as a result of the scanning, the database metadata and the associated software product metadata.

3. The method of claim 2 further comprising:
identifying a bundling relation between the registered database and the software product based on the retrieved database metadata and the retrieved software product metadata.

4. The method of claim 1 wherein the software product metadata includes a product name and a product version.

5. The method of claim 1 wherein the database metadata is stored in a database metadata entry and wherein the software product metadata is stored in a software product metadata entry.

6. The method of claim 1 further comprising:
registering a plurality of databases, including the database, at the database manager and storing their respective database metadata in the metadata data store;
storing a plurality of software product metadata entries corresponding to a plurality of software products, including the software product, in the metadata data store;
associating each of the plurality of software product metadata with one of the registered databases, wherein the number of registered databases is greater than the plurality of software product metadata entries;
scanning the plurality of databases stored in the metadata data store; and
identifying a plurality of bundling relations between the plurality of databases and the plurality of software products based on the associations revealed by the scanning.

7. The method of claim 6 wherein the scanning further includes issuing one or more list database directory commands which lists the databases included in the metadata data store.

8. A method implemented by an information handling system comprising: registering a plurality of databases at a database manager, wherein the registering includes:
receiving a plurality of database metadata corresponding to each of the databases; and
storing, in a metadata data store maintained by the database manager, the received database metadata;
associating a plurality of software products with a plurality of the registered databases, wherein the associating includes:
receiving a plurality of software product metadata corresponding to each of the plurality of software products; and
storing, in the metadata data store maintained by the database manager, the received software product metadata, wherein the stored software product metadata is associated with the stored database metadata.

9. The method of claim 8 further comprising:
backing up one or more of the databases in response to an execution of a backup database command;
preserving the metadata data store in a backup data store in response to backing up the one or more databases.

10. The method of claim 9 further comprising:
restoring a selected one of the backed up databases, wherein the restoring includes restoring the database metadata and the associated software product metadata corresponding to the selected database.

11. The method of claim 8 further comprising:
receiving a request to remove a selected one of the plurality of databases; and
removing, from the metadata data store, the database metadata and the associated software product metadata corresponding to the selected database from the metadata data store.
